(19) United States
(12) Patent Application Publication
(10) Pub. No.: US 2021/0203569 A1
(43) Pub. Date: Jul. 1, 2021

(54) VISUAL DEVELOPMENT ENVIRONMENT FOR ADVANCED DISCOVERY PATTERNS

(71) Applicant: ServiceNow, Inc., Santa Clara, CA (US)

(72) Inventors: Asaf Garty, Sdei Hemed (IL); Daniel Badyan, Tel Aviv (IL); Robert Bitterfeld, Petach Tikva (IL)

(21) Appl. No.: 16/731,559

(22) Filed: Dec. 31, 2019

(51) Int. Cl. H04L 12/24; G06F 3/0481

(52) U.S. Cl. CPC H04L 41/22; G06F 3/04817; H04L 41/12

(57) ABSTRACT

A system may contain a library of graphical icons and a representation of a discovery pattern, wherein the discovery pattern includes a series of steps and directional connections, wherein the steps are respectively associated with identifiers, program logic to perform operations of the discovery pattern, and instances of the graphical icons. The system may further include one or more computing devices configured to: generate a graph of graphical icons associated with the steps, with connectors indicating directional connections therebetween, and a menu of the graphical icons from the library; receive an indication that an additional graphical icon has been connected to the graph with an additional connector; update the representation of the discovery pattern to include the additional step associated with the additional graphical icon and an additional directional connection associated with the additional connector; and store the updated discovery pattern in persistent storage.

### BACKGROUND

In order for multi-device networks to be properly managed, it is desirable to determine or “discover” what computing devices are present. Discovery may also involve obtaining information about the computing devices such as the configurations of the computing devices, operational statuses of the computing devices, and the applications and services provided by the computing devices. Additionally, discovery may also determine the relationships between discovered devices, applications, and services. All of these procedures may require a multitude of steps and/or commands to gather the desired data. These steps or commands, in aggregate, may be referred to as a discovery pattern. Support for discovery patterns is currently limited to a linear sequence of steps and does not include certain programming language functionality. As computing device complexity grows, it would be advantageous to be able to remove such limits, while also adding more flexibility in how discovery patterns can be designed.

### SUMMARY

Complex modern computing devices, such as routers, databases, and/or clustered servers with virtual machines, may require specific discovery patterns to facilitate their full discovery. For example, such devices may have authentication procedures, command line interfaces, and/or representational states transfer (REST) interfaces through which their properties can be discovered. Without support for fundamental features of modern programming languages, such as branching, loops, jumps, and parallelism, discovery patterns are limited in how well they can support these devices. In some cases, if patterns can be written at all, they may require an extensive amount of programming per step. This may result in pattern development being beyond the scope of many individuals' skills. For example, many information technology (IT) professionals may be unable to write effective patterns for equipment that is disposed within their networks.

The embodiments herein provide graphical user interfaces (GUIs) that simplify discovery pattern design. Particularly, the GUIs allow discovery steps to be visually arranged into graphs that represent more complex patterns. These graphs may include drag-and-drop support for specifying steps and the ordering thereof, as well as branching, loops, jumps, and parallelism. Such a visual representation of a pattern may simplify pattern design by reducing or eliminating the amount of code that needs to be written. Further, the visual representation may enable inexperienced programmers to be able to intuitively develop and/or edit discovery patterns that would otherwise be beyond their skills.

Accordingly, a first example embodiment may involve a computational instance. The computational instance may include persistent storage containing a library of graphical icons and a representation of a discovery pattern, wherein the discovery pattern includes a series of steps and directional connections between pairs of the steps, wherein the steps are respectively associated with: (i) instances of graphical icons from the library, (ii) identifiers, and (iii) program logic executable to perform operations of the discovery pattern, wherein the steps include an initial step at which the discovery pattern begins, and one or more final steps at which the discovery pattern ends. The computational instance may further include one or more computing devices configured to generate and provide, for display on a GUI, (i) a graph of the instances of graphical icons associated with the steps, with connectors indicating the directional connections between the pairs of the steps, and (ii) a menu of at least some of the graphical icons from the library. The one or more computing devices may further be configured to receive an indication that an additional graphical icon from the library has been connected to a target graphical icon of the graph by an additional connector, wherein the additional graphical icon has an additional identifier and additional program logic. The one or more computing devices may further be configured to, in response to receiving the indication, update the representation of the discovery pattern to include an additional step and an additional directional connection between the additional step and a target step represented by the target graphical icon, wherein the additional step is associated with the additional graphical icon, the additional identifier, and the additional program logic. The one or more computing devices may further be configured to store, in the persistent storage, the representation of the discovery pattern as updated.

A second example embodiment may involve generating and providing, for display on a GUI, (i) a menu of at least some graphical icons of a library of graphical icons, and (ii) a graph of instances of graphical icons associated with steps of a discovery pattern, with connectors indicating directional connections between pairs of the steps, wherein persistent storage contains the library of graphical icons and a representation of the discovery pattern, wherein the steps are also respectively associated with identifiers and program logic executable to perform operations of the discovery pattern, wherein the steps include an initial step at which the discovery pattern begins, and one or more final steps at which the discovery pattern ends. The second example embodiment may further involve receiving an indication that an additional graphical icon from the library has been connected to a target graphical icon of the graph by an additional connector, wherein the additional graphical icon has an additional identifier and additional program logic. The second example embodiment may further involve, in response to receiving the indication, updating the representation of the discovery pattern to include an additional step and an additional directional connection between the additional step and a target step represented by the target graphical icon, wherein the additional step is associated with the additional graphical icon, the additional identifier, and the additional program logic. The second example embodiment may further involve storing, in the persistent storage, the representation of the discovery pattern as updated.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a GUI related to a conventional discovery pattern, in accordance with example embodiments.

FIG. 7A depicts a GUI related to creating an advanced discovery pattern, in accordance with example embodiments.

FIG. 7B depicts another GUI related to creating an advanced discovery pattern, in accordance with example embodiments.

FIG. 8 depicts a GUI related to editing a discovery pattern step, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data is stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

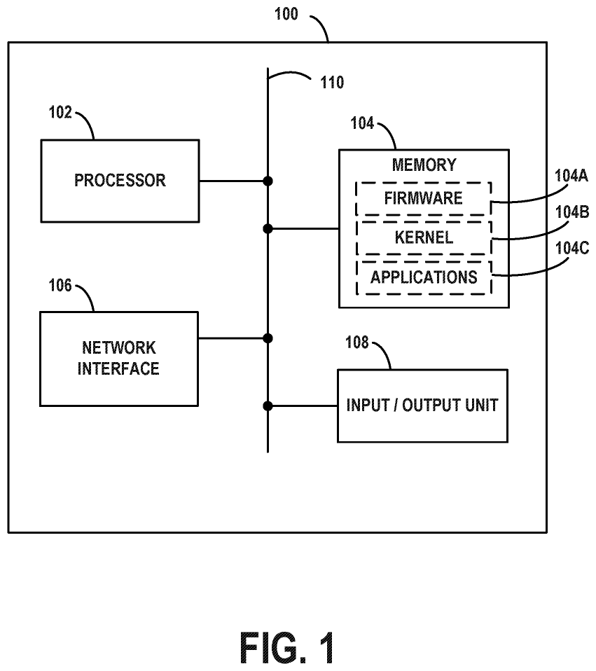

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

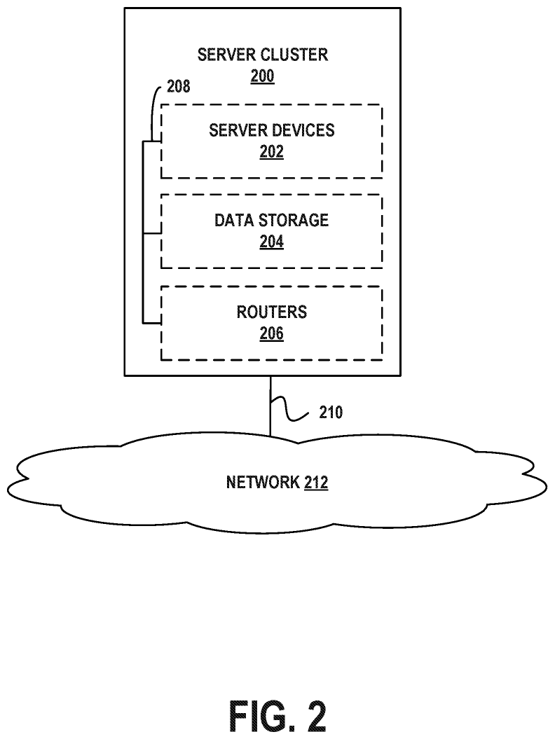

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

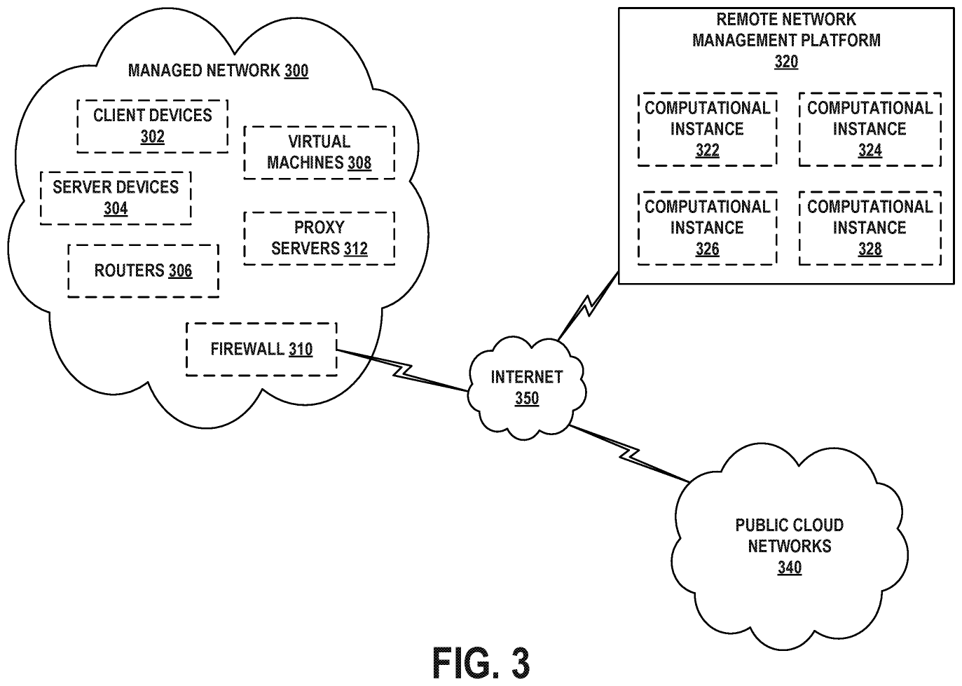

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

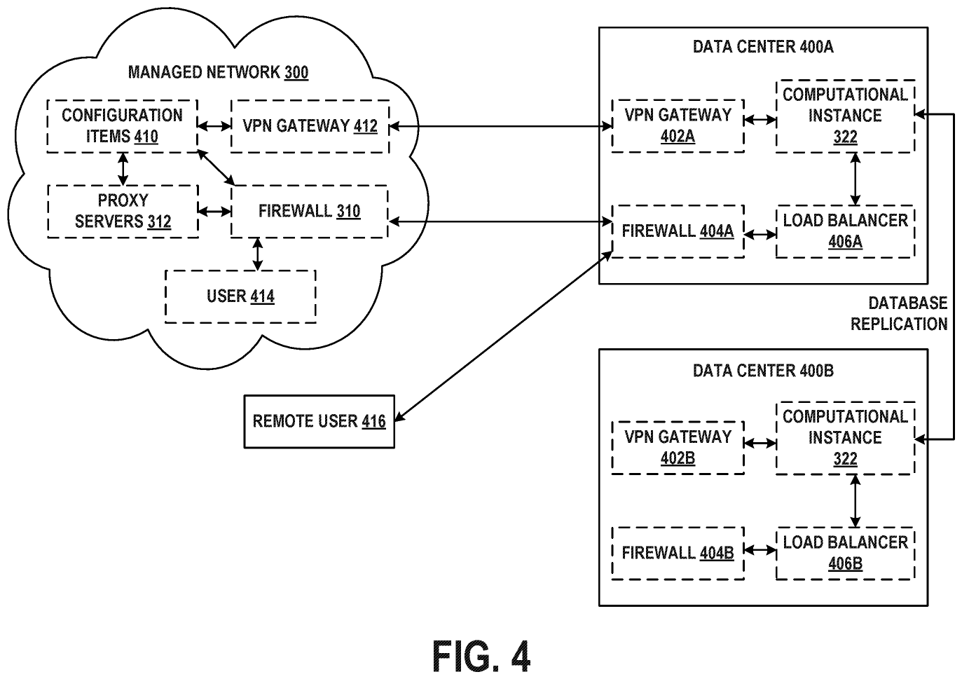

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

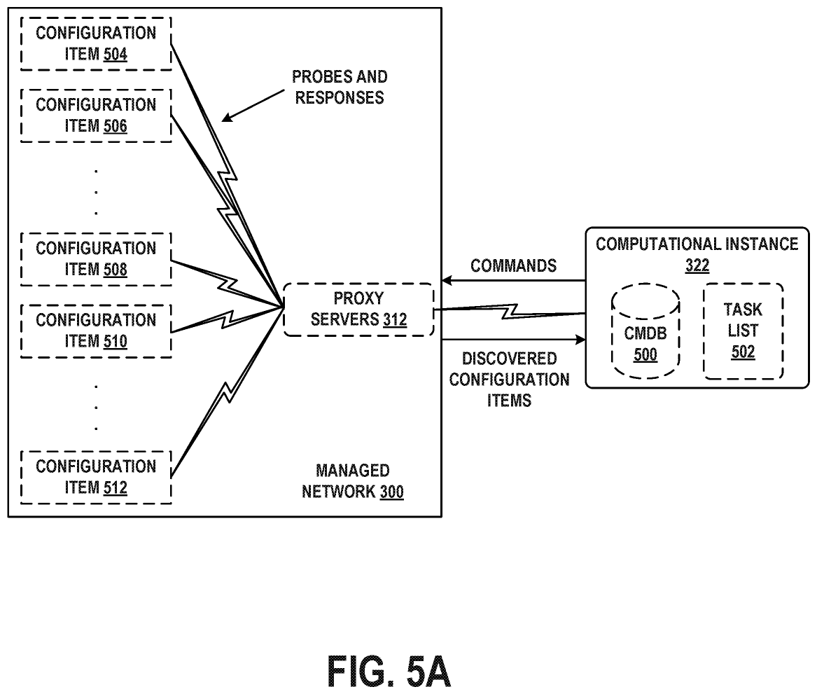

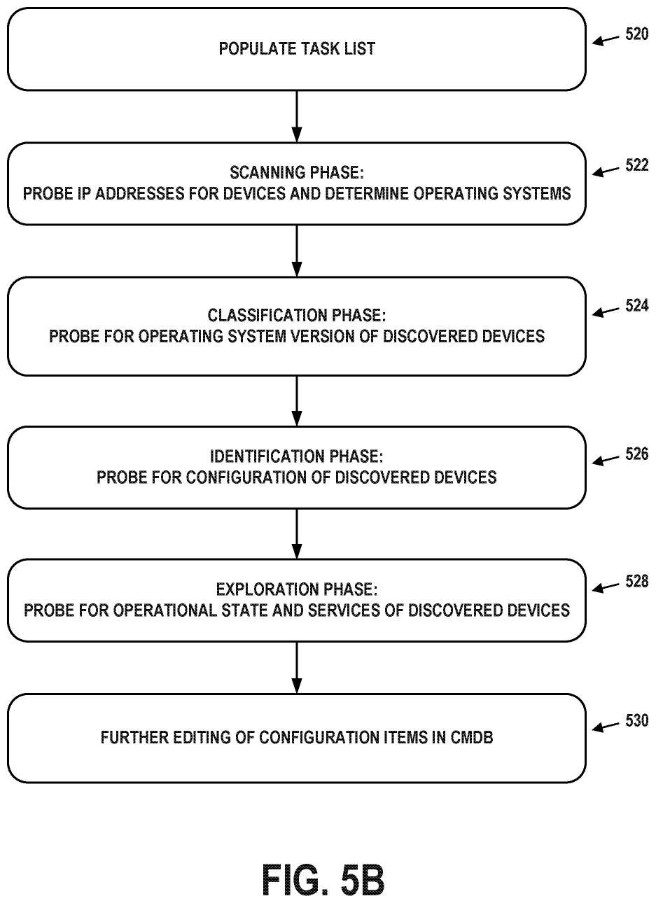

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. EXAMPLE DISCOVERY PROCESSES AND PATTERNS

In order to carry out discovery, a discovery pattern may execute a number of steps or commands to probe devices on a managed network. For example, the IT personnel may test a communication port of a certain computing device on the managed network, then once it is confirmed that the communication port is operating, the IT personnel then may launch discovery on the device remotely to collect data on the software installed on the computing device. Doing so may be supported by a discovery application executable on a computational instance. The discovery application may execute a discovery pattern, which may carry out a sequence of commands that discovers the properties of the computing device.

The discovery application may have a library of predefined steps or commands that can be incorporated into such patterns. For example, the discovery application may include commands that probe the open TCP and/or UDP ports of a computing device to determine what kind of operating system it is executing (e.g., if a computing device has TCP port 22 open, it is almost certainly using a variation of UNIX® as its operating system). Further commands may use pre-configured credentials (e.g., a userid and password) to log on the computing device. Other commands may read values from configuration files or other resources to determine the version of the operating system, the number of processors, the amount of memory available to the computing device, open communication sessions to other computing devices, and so on.

A. Discovery Pattern GUI

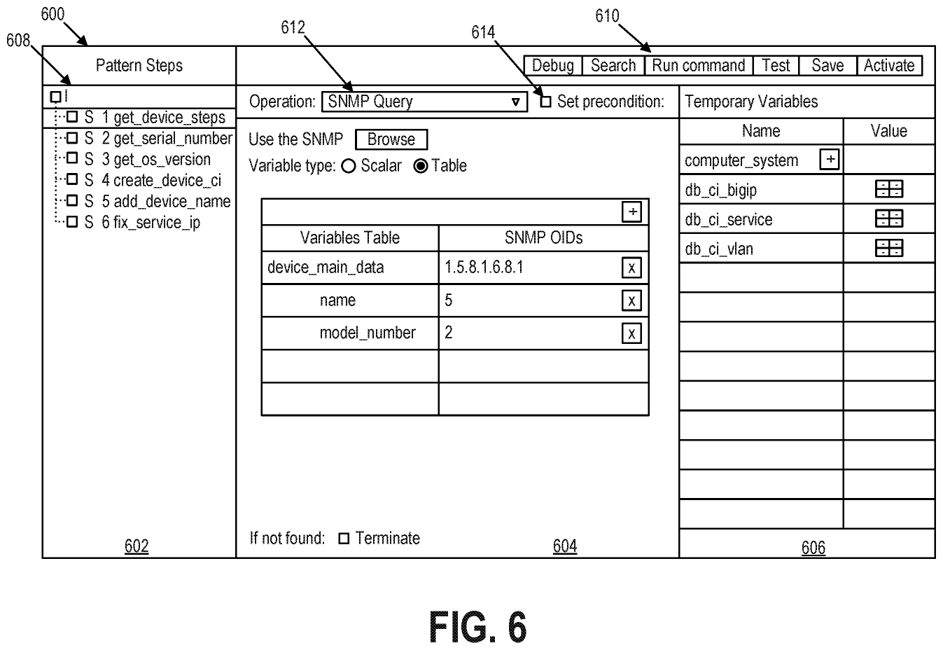

FIG. 6 depicts GUI 600 related to a conventional way of designing and displaying a discovery pattern. GUI 600 is an example that the further embodiments below may improve on.

GUI 600 may include panel 602, where a sequential list 608 of steps that make up a particular discovery pattern is displayed. The discovery pattern, when executed, may carry out these steps in the enumerated order (e.g., step 1 first, step 2 second, and so on). Actuating (e.g., touching, clicking on, or hovering over) a step in sequential list 608 may cause details related to that step to be displayed in panel 604 and/or panel 606.

Panel 604 displays operational information and options related to a particular step. Panel 604 may include selection field 612, a drop-down menu from which the user can select different commands. For example, the “SMNP query” command shown may execute a SMNP query on a computing device. In another example, a “Get registry key” command may query a WINDOWS® computing device for one or more registry keys. Panel 604 may also include check box 614 that may be used to set a precondition. When such a precondition is set, that precondition must be met for the step to be executed.

GUI 600 may further include panel 606 where the data associated with and/or gathered by the discovery pattern is displayed. For example, the data may include a temporary array variable called “computer system” that includes information about the computing device the discovery pattern is probing, such as what operation system is executed by the computing device. In another example, the data may include a temporary array variable that contains information about a process executing on the computing device, such as the directory path to the file that was executed to launch the process.

GUI 600 may also include an array of buttons 610 where different operations can be executed on the discovery pattern as a whole or on the command currently displayed in panel 604. These operations may include entering a debug mode, searching for commands or other information related to commands, running a command, testing the discovery pattern or a command thereof, saving the discovery pattern to a database (e.g., CMDB 500), or activating the discovery pattern so that it can be used by others.

A user may open user interface 600 to create a new discovery pattern or edit an existing discovery pattern. If the user is creating a new discovery pattern, the sequential list 608 may only include an initial default step that the user can edit. If the user is editing an existing discovery pattern, the current steps of the discovery pattern may be displayed in panel 602 as sequential list 608.

To add a step to the discovery pattern, the user may actuate—e.g., by way of right-clicking—a particular step in the sequential list 608. The user may be presented with a menu through which the user can choose to place the new step before or after the particular step. Then, the new step may be created and placed in the order respective to which option the user chose. To change the order of existing steps in a discovery pattern, the user may click and drag the steps in the sequential list 608 into the desired order.

The user may define temporary variables in panel 606, and specify how each is calculated. For example some may take their values from associated output of the command shown in panel 604. Then, these variables may be written to the database in particular columns of particular tables. Alternatively, input to a command shown in panel 604 may be based on values from the database, and these values may be stored in the temporary variables until no longer needed.

Despite the general usefulness of being able to define discovery patterns, there are drawbacks to the embodiment of GUI 600. The order in which the steps are executed is linear. This may prevent a sequence of steps from being executed repeatedly in a looping manner. This also may prevent branches among the steps, where each branch of steps is executed conditionally. Further, this may prevent skipping steps based on certain conditions.

B. Advanced Discovery Pattern GUI

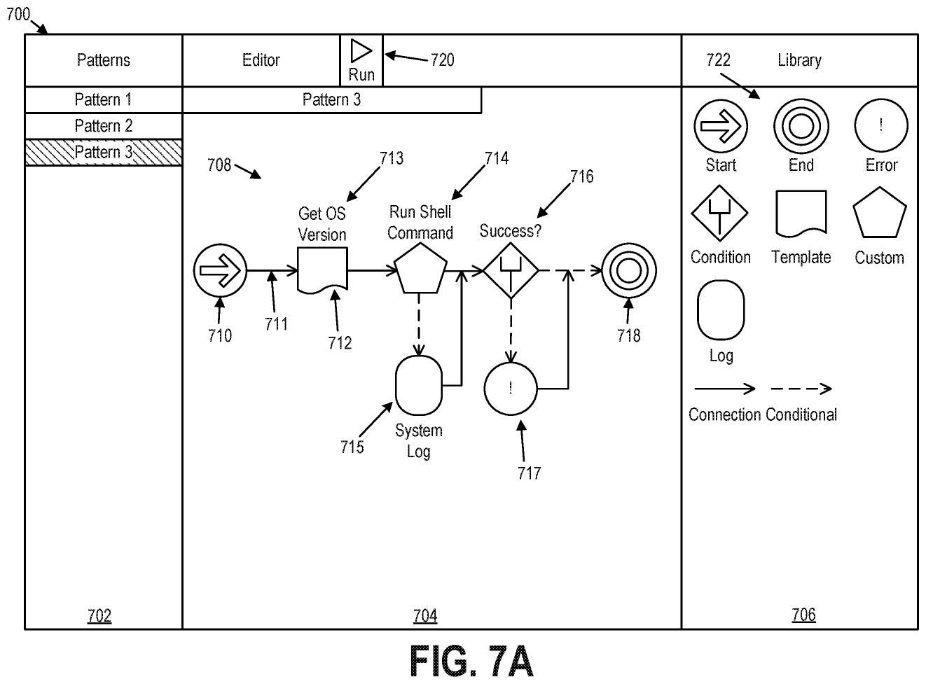

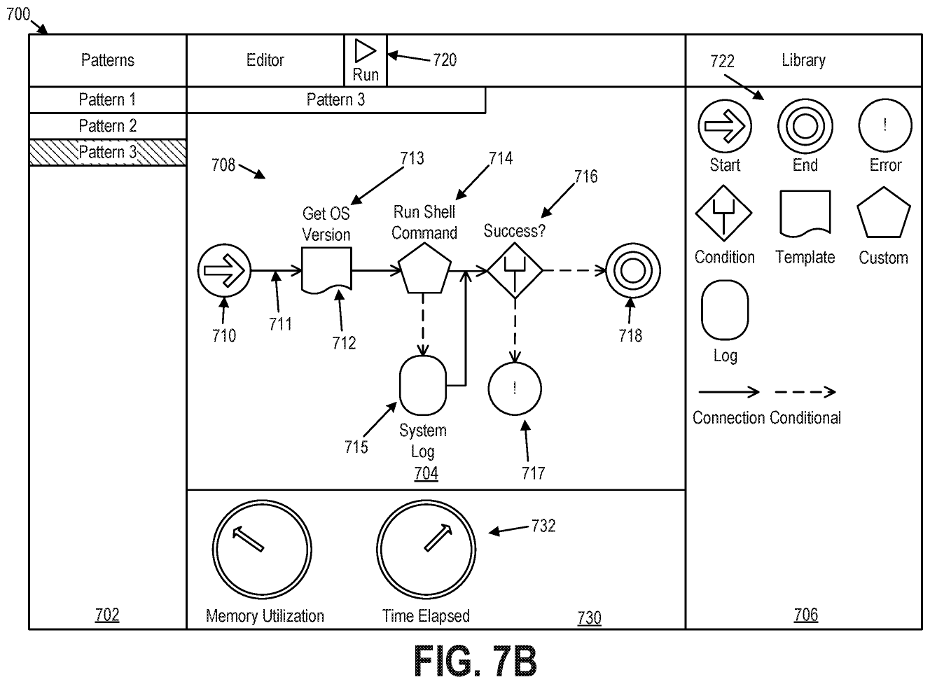

FIG. 7A depicts GUI 700, a more advanced user interface that can be used to visually create a discovery pattern that supports conditional execution, branches, jumps, loops, and parallelism. In particular, GUI 700 allows a discovery pattern to be defined by arranging a set of graphical icons and connectors therebetween on a screen. This may result in a significant improvement over conventional discovery pattern design tools.

Each step of the discovery pattern may be associated with an instance of a graphical icon, and may include an identifier and program logic to be executed. The graphical icon may be from a library of graphical icons, where each type of step is represented by a different graphical icon. For example, there may be a certain graphical icon for steps that produce alerts. The identifier may be a string of characters, possibly defined by the user, that describe the associated program logic. For example, a step where the associated program logic probes a computing device to determine the operating system version of the computing device may have an identifier named “Get OS Version”. The program logic may be a set of programming commands that is executed for that step of the discovery pattern.

The graphical icons may be linked by connectors. These connectors may be represented on GUI 700 as arrows indicating the ordering of the steps represented by the graphical icons (and thus the control flow of the discovery pattern). Some connectors may be associated with conditional logic, such as logic that checks the state of a variable. The connectors associated with conditional logic may be referred to as conditional connectors. The combination of graphical icons and connectors form a graph that represents the discovery pattern.

1. Pattern Selector Panel

GUI 700 may include panel 702 that lists discovery patterns that are stored in a database. In response to actuating a discovery pattern in the list, panel 704 may be updated to display graph 708 representing the discovery pattern. For example, “Pattern 3” may be selected from the list of panel 702, and then its respective entry may indicate that it has been selected. To that point, the selected discovery pattern may be shaded as shown in FIG. 7A.

To add a discovery pattern to panel 702, the user may actuate—e.g., by way of right-clicking—an existing discovery pattern in panel 702. The user may be presented with a menu through which the user can choose to place the new discovery pattern before or after the existing discovery pattern. Then, the new discovery pattern may be created and placed in the order respective to which option the user chose. Similarly, the menu may provide options for deleting the existing discovery pattern. In situations where no discovery patterns are defined, actuating anywhere in panel 702 may result in the user being presented with a menu through which a new discovery pattern can be created.

2. Pattern Display Panel

Panel 704 may be used to display and interact with a graphical representation of a discovery pattern selected by way of panel 702. Particularly, panel 704 may include graph 708 that is a graphical representation of a discovery pattern. Graph 708 may be comprised of graphical icons, such as graphical icon 712, that represent steps of the discovery pattern. Graph 708 may also include connectors, such as connector 711, that represent the directional connections between the steps of the discovery pattern. Graphical icon 710 denotes the start of the discovery pattern, representing its initial step. Graphical icon 718 denotes the end of the discovery pattern. A graph, such as graph 708, may contain one starting graphical icon and one or more ending graphical icons representing final steps.

The connectors may denote the order of which the steps of the discovery pattern are executed. Thus, when a connector abuts to a first graphical icon with its tail (non-arrow) end and to a second graphical icon with its head (arrow) end, the step in the discovery pattern represented by the first graphical icon would be executed before the step represented by the second graphical icon. Connectors may also be used to form loops over one or more graphical icons. The associated steps would then be repeatedly executed. In some cases, self-loops (a loop from a graphical icon to itself) may be supported. Conditional logic may determine the number of times that the steps within the loop are executed.

A particular graphical icon may have more than one connector leaving it, facilitating conditional execution. The conditions tested may be mutually exclusive. For example, a particular graphical icon may represent a step that has two conditional connectors leaving it. The particular step may be associated with program logic that performs a test (e.g., checking the value of a Boolean variable). The conditional logic of the two conditional connectors may check the result of the test. One of these connections may be followed when the result is “true” and the other may be followed when the result is “false”. As a consequence, a branch is facilitated.

In cases where a graphical icon has two or more non-conditional connectors leaving it, parallel execution may be triggered. In particular, suppose that graphical icon A abuts to the tail ends of two non-conditional connectors respectively leading to graphical icons B and C. Then, the steps represented by graphical icons B and C may be carried out in parallel when the discovery pattern is executed.

Thus, by combining graphical icons and direction connections in various ways, conditional execution, branches, loops, jumps, and parallelism may be supported by discovery patterns. This results in a more flexible and adaptable development environment for discovery patterns that support more features than the development environment of FIG. 6.

Some graphical icons of graph 708 may be associated with a title, such as title 713. The title may display an identifier for the step that the graphical icon represents. Such an identifier may be defined by a user or automatically generated (e.g., generated based on incrementing numbers, for example). Identifiers may be unique per graph.

Panel 704 may also include button 720 that, when actuated, starts the execution of the discovery pattern represented by graph 708. If a particular graphical icon is highlighted or selected when button 720 is actuated, the execution may be limited to only the step represented by that graphical icon.

Notably, graphical icons and connectors can be added and removed from panel 704 (e.g., by right-clicking on the graphical icons and selecting such options from a menu). They can also be rearranged, reordered, and edited. Rearranging may involve dragging the graphical icons or connectors to other locations on panel 704. Reordering may involve changing the graphical icons with which the connectors are associated. Editing may involve left-clicking on a graphical icon or directional connector to add, change, or delete its identifier and/or program logic.

3. Graphical Icon Library Panel

GUI 700 may further include panel 706 that displays a library 722 of graphical icons and connectors that can be used for representing the steps and control flow of a discovery pattern. Panel 706 may display some or all graphical icons and connectors that are available. Graph 708 may be constructed by dragging and dropping graphical icons and connectors from library 722 to panel 704.

The graphical icons in library 722 may visually represent different types of steps for discovery patterns. For example, there may be a certain type of graphical icon that represents the start of a discovery pattern, such as the “Start” icon in library 722. This graphical icon may represent where execution of the discovery pattern begins. As noted above, there might be only one “Start” icon per graph.

There also may be a graphical icon that represents predefined or template steps where the associated program logic is predefined with default commands, such as the “Template” icon in library 722. When a “Template” icon is dragged to panel 704, the user may be prompted to select its functionality from a pre-defined menu.

There also may be a graphical icon that represents a custom step where the associated program logic has not been defined before being added to a discovery pattern, such as the “Custom” icon in library 722. When a “Custom” icon is dragged to panel 704, the user may be prompted to define its functionality.

There also may be a graphical icon that represents the end of a discovery pattern, such as the “End” icon in library 722. This graphical icon may represent where execution of a discovery pattern can terminate. Due to possible conditional execution, there may be one or more “End” icons in a graph.

There also may be a graphical icon that represents a step that provides an error indication, such as the “Error” icon in library 722. As an example, example, the “Error” icon may represent a step that flags a problem when a command in a discovery pattern has failed. In another example, this icon may represent a step that sends an alert to a user when a particular step of the discovery pattern has been completed.

There also may be a graphical icon that represents a step that logs data to a file, such as the “Log” icon in library 722. The logged data may include fixed values, values of one or more variables used by the pattern, or any combination thereof.

There also may be a graphical icon that represents a step that executes a command that may be followed by connectors with associated conditional logic, such as the “Condition” icon in library 722. For example, there may be a particular step in a discovery pattern that retrieves a registry key. There may also be two conditional connectors with their tail ends abutting to the graphical icon that represents the particular step. One conditional connector may only execute its following step(s) if the registry key starts with a numeric character and the other conditional connector may only execute its following step(s) if the registry key starts with non-numeric character.

Library 722 may also include graphical representations of the connectors. These graphical representations may be placed in between graphical icons in the graph 708. There may be a default connector, such as the “Connection” icon in library 722. The default connector may be used to represent a non-conditional connection between graphical icons. There also may be a conditional connector, such as the “Conditional” icon in library 722. As noted above, such a conditional connector may include associated conditional logic that needs to be met in order for the connector's following step to be executed.

In some embodiments, the discovery pattern of graph 708 might not be able to be executed until there is a starting graphical icon, at least one ending graphical icon, all graphical icons connected to the graph, and all connectors abutting to two graphical icons. Other conditions for execution of a discovery pattern may be possible.

4. Discovery Pattern Interpretation

Given all of this, the example discovery pattern represented by graph 708 may be interpreted as follows. The discovery pattern starts at the graphical icon 710. Directional connector 711 leads to graphical icon 712. The step represented by graphical icon 712 is associated with identifier 713, “Get OS Version”. Thus, this step may be associated with program logic that comprises commands to detect what version of the operating system is installed on the device the discovery pattern is probing.

Graphical icon 714 is labeled with the identifier “Run Shell Command.” Thus, the represented step may be associated with program logic that executes a command in the probed devices' command line interface. There are two connectors following graphical icon 714. One connector is a default connector that connects to graphical icon 716, “Success?” The other connector is a conditional connector that leads to graphical icon 715, “System Log”. Thus, there may be a certain outcome of the program logic of the “Run Shell Command” step represented by graphical icon 714 that causes the “System Log” step represented by graphical icon 715 to create a log. For example, if the command of graphical icon 714 fails, results of that step may be logged into a text file. The connector leaving graphical icon 715 leads to graphical icon 716. Thus, after the “System Log” step represented by graphical icon 715 is completed, the following step is the same step that would have be executed if the conditional logic of the previous connectors had not been met.

Graphical icon 716 has two conditional connectors leaving it. One leads to graphical icon 717, “Error”. The other leads to graphical icon 718, “End”. Thus, graphical icon 716 may be associated with program logic that checks if the previous step was successful. Based on the outcome, the discovery pattern may either: (i) end at the step of graphical icon 718, or (ii) raise an error at the step of graphical icon 717, then end at the step of graphical icon 718.

5. Integrated Performance Metrics

FIG. 7B depicts a further example embodiment of GUI 700; notably, panel 730 has been added below panel 704. Panel 730 represents performance metrics of the discovery pattern represented by graph 708. For example, the performance metrics may take the form of visual representations, such as gauges 732. But may also take other forms such as progress bars, pie charts, and so on. The performance metrics also may be displayed as their respective numeric values.

These performance metrics may include, but are not limited to, memory utilization associated with a particular step, processor utilization associated with the particular step, or time duration associated with the performance of the particular step. In some cases, the performance metrics may be based on the execution of the discovery pattern as a whole rather than a particular step. This memory utilization, processor utilization, or time duration may be of the computational instance carrying out the step or discovery pattern.

These performance metrics are helpful for discovery pattern development, because they can be used to rapidly identify inefficient steps of a discovery pattern. Thus, a pattern developer can consider alternative implementation strategies. Conventional discovery pattern development environments do not have such functionality.

6. Editing of a Step

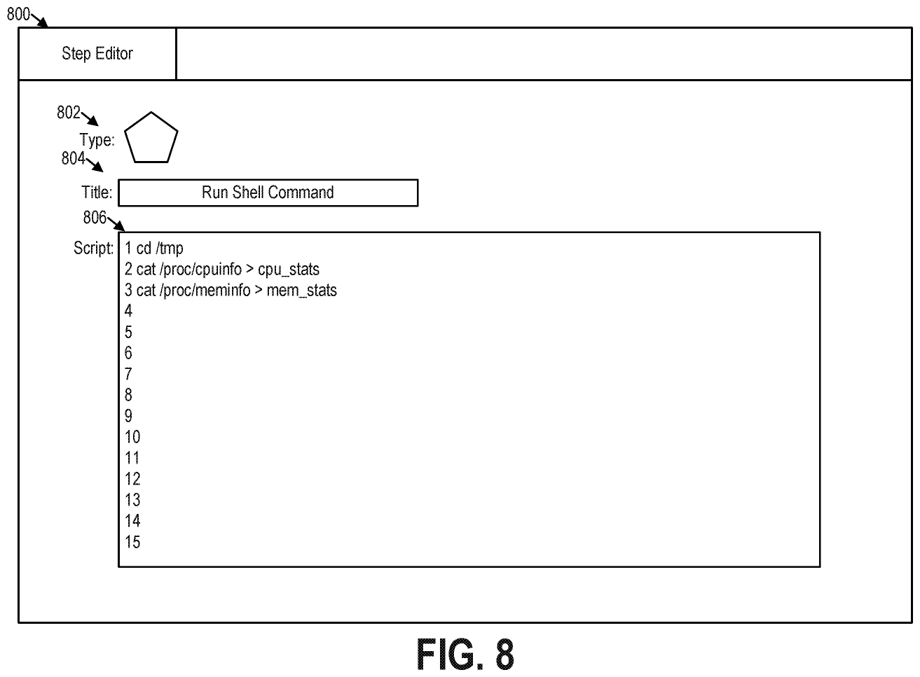

As noted above, example embodiments may be used to edit an existing discovery pattern. FIG. 8 depicts an example GUI 800 that may be used to edit a particular step of a discovery pattern. GUI 800 may be displayed when a user actuates a graphical icon, such as graphical icon 714.

Type indicator 802 may represent the type of the graphical icon being edited. The shape may match that of a graphical icon from library 722.

Text box 804 displays the identifier associated with the graphical icon being edited. The identifier may be edited by the user through the text box 804. Changing the identifier may cause the graphical representation of the identifier to update in graph 708.

Text box 806 displays the program logic of the particular discovery pattern step. The actions of the particular discovery pattern step may be represented by programming code, such as a BASH or NDL script, which can be edited in the text box 806. For instance, the script shown in text box 806 may be used to write processor and memory information related to the computing device being probes to respective files. These files may later be retrieved, parsed, and relevant information therein written to the database.

C. Example Operations

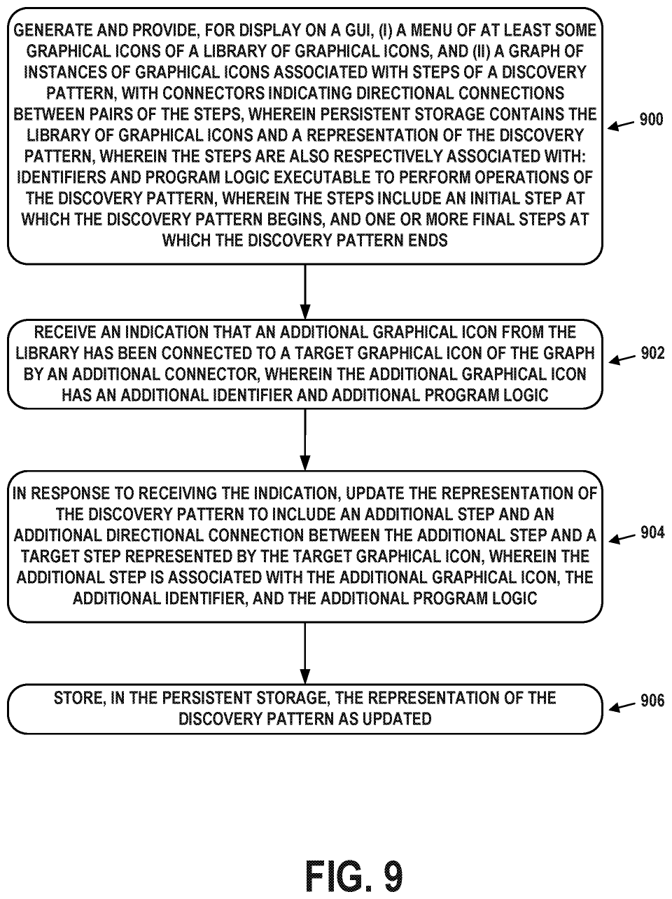

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems, such as computational instance 322.

The embodiments of FIG. 9 may be simplified by the removal of any one or more of the features shown therein. Further, these embodiments may be combined with features, aspects, and/or implementations of any of the previous figures or otherwise described herein.

Block 900 may involve generating and providing, for display on a GUI, (i) a menu of at least some graphical icons of a library of graphical icons, and (ii) a graph of instances of graphical icons associated with steps of a discovery pattern, with connectors indicating directional connections between pairs of the steps, wherein persistent storage contains the library of graphical icons and a representation of the discovery pattern, wherein the steps are also respectively associated with identifiers and program logic executable to perform operations of the discovery pattern, wherein the steps include an initial step at which the discovery pattern begins, and one or more final steps at which the discovery pattern ends.

Block 902 may involve receiving an indication that an additional graphical icon from the library has been connected to a target graphical icon of the graph by an additional connector, wherein the additional graphical icon has an additional identifier and additional program logic. In some embodiments, the additional graphical icon being connected to the target graphical icon by the additional connector may comprise (i) actuating, by way of the GUI, one of the graphical icons from the library displayed thereon to create the additional graphical icon; (ii) dragging, by way of the GUI, the additional graphical icon to the graph; and (iii) adding, by way of the GUI, the additional connector between the target graphical icon and the additional graphical icon.

Block 904 may involve, possibly in response to receiving the indication, updating the representation of the discovery pattern to include an additional step and an additional directional connection between the additional step and a target step represented by the target graphical icon, wherein the additional step is associated with the additional graphical icon, the additional identifier, and the additional program logic.

Block 906 may involve storing, in the persistent storage, the representation of the discovery pattern as updated.

In some embodiments, the process illustrated in FIG. 900 may further involve receiving an further indication that a further graphical icon in the graph has been moved from a first position to a second position and one or more connectors involving the further graphical icon have been updated, wherein the further graphical icon is associated with a particular step in the series of steps. In further embodiments, the process may involve, in response to receiving the further indication, updating the representation of the discovery pattern to include the particular step ordered in the series of steps in accordance with the one or more connectors as updated. In further embodiments, the process may involve, storing, in the persistent storage, the representation of the discovery pattern as updated.

In some embodiments, the process illustrated in FIG. 900 may further involve performing the discovery pattern on one or more computing devices of a target network, wherein performing the discovery pattern comprises: (i) traversing the steps in an ordering defined by the directional connections between the pairs of the steps, and (ii) for each step visited during the traversing, executing the associated program logic.

In some embodiments, the process illustrated in FIG. 900 may further involve generating and providing, for display on the GUI, a graphical indicator of a performance metric associated with the particular step. In further embodiments, the performance metric may comprise: (i) memory utilization associated with the particular step, (ii) processor utilization associated with the particular step, or (iii) a time duration associated with the performance of the particular step. In further embodiments, the graphical indicator may be a gauge that visually represents the performance metric on a labelled scale, wherein the labelled scale includes zones that categorize efficacy of the performance of the particular step.

In some embodiments, the identifiers may comprise user-defined textual descriptions of the associated steps.

In some embodiments, the directional connections may define the ordering of the steps from the initial step to the one or more final steps. In further embodiments, a particular step in the series of steps may have a directional connection to a second particular step in the series of steps, wherein the second particular step is disposed before the particular step in the ordering of the steps.

In some embodiments, a particular step in the series of steps may have two or more directional connections from the particular step to other steps in the series of steps.

In some embodiments, a particular step in the series of steps may have two or more directional connections from other steps in the series of steps to the particular step.

In some embodiments, a particular step in the series of steps may have a directional connection to itself.

In some embodiments, at least one of the steps may be associated with program logic that remotely probes a computing device on a target network to determine an operating system or operating system version of the computing device.

In some embodiments, a particular step of the steps may be associated with program logic that: (i) remotely executes one or more shell commands on a computing device to gather configuration information related to the computing device, or (ii) remotely accesses the computing device by way of a network management interface to gather the configuration information. In further embodiments, a second particular step of the steps may be associated with program logic that: (i) writes some of the configuration information to a log in the persistent storage, or (ii) creates or updates configuration item database entries in the persistent storage based on the configuration information.

### VI. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a library of graphical icons and a representation of a discovery pattern, wherein the discovery pattern includes a series of steps and directional connections between pairs of the steps, wherein the steps are respectively associated with: (i) instances of graphical icons from the library, (ii) identifiers, and (iii) program logic executable to perform operations of the discovery pattern, wherein the steps include an initial step at which the discovery pattern begins, and one or more final steps at which the discovery pattern ends; and
one or more computing devices configured to:
generate and provide, for display on a graphical user interface (GUI), (i) a graph of the instances of graphical icons associated with the steps, with connectors indicating the directional connections between the pairs of the steps, and (ii) a menu of at least some of the graphical icons from the library;
receive an indication that an additional graphical icon from the library has been connected to a target graphical icon of the graph by an additional connector, wherein the additional graphical icon has an additional identifier and additional program logic;
in response to receiving the indication, update the representation of the discovery pattern to include an additional step and an additional directional connection between the additional step and a target step represented by the target graphical icon, wherein the additional step is associated with the additional graphical icon, the additional identifier, and the additional program logic; and
store, in the persistent storage, the representation of the discovery pattern as updated.

2. The system of claim 1, wherein the identifiers comprise user-defined textual descriptions of the associated steps.

3. The system of claim 1, wherein the directional connections define an ordering of the steps from the initial step to the one or more final steps.

4. The system of claim 3, wherein a particular step in the series of steps has a directional connection to a second particular step in the series of steps, wherein the second particular step is disposed before the particular step in the ordering of the steps.

5. The system of claim 1, wherein a particular step in the series of steps has two or more directional connections from the particular step to other steps in the series of steps.

6. The system of claim 1, wherein a particular step in the series of steps has two or more directional connections from other steps in the series of steps to the particular step.

7. The system of claim 1, wherein a particular step in the series of steps has a directional connection to itself.

8. The system of claim 1, wherein at least one of the steps is associated with program logic that remotely probes a computing device on a target network to determine an operating system or operating system version of the computing device.

9. The system of claim 1, wherein a particular step of the steps is associated with program logic that: (i) remotely executes one or more shell commands on a computing device to gather configuration information related to the computing device, or (ii) remotely accesses the computing device by way of a network management interface to gather the configuration information.

10. The system of claim 9, wherein a second particular step of the steps is associated with program logic that: (i) writes some of the configuration information to a log in the persistent storage, or (ii) creates or updates configuration item database entries in the persistent storage based on the configuration information.

11. The system of claim 1, wherein the additional graphical icon being connected to the target graphical icon by the additional connector comprises:
actuating, by way of the GUI, one of the graphical icons from the library displayed thereon to create the additional graphical icon;
dragging, by way of the GUI, the additional graphical icon to the graph; and
adding, by way of the GUI, the additional connector between the target graphical icon and the additional graphical icon.

12. The system of claim 1, wherein the one or more computing devices are further configured to:
receive an further indication that a further graphical icon in the graph has been moved from a first position to a second position and one or more connectors involving the further graphical icon have been updated, wherein the further graphical icon is associated with a particular step in the series of steps;
in response to receiving the further indication, update the representation of the discovery pattern to include the particular step ordered in the series of steps in accordance with the one or more connectors as updated; and
store, in the persistent storage, the representation of the discovery pattern as updated.

13. The system of claim 1, wherein the one or more computing devices are further configured to:
perform the discovery pattern on one or more computing devices of a target network, wherein performing the discovery pattern comprises: (i) traversing the steps in an ordering defined by the directional connections between the pairs of the steps, and (ii) for each step visited during the traversing, executing the associated program logic.

14. The system of claim 1, wherein the one or more computing devices are further configured to, during performance of a particular step of the discovery pattern:
generate and provide, for display on the GUI, a graphical indicator of a performance metric associated with the particular step.

15. The system of claim 14, wherein the performance metric comprises: (i) memory utilization associated with the particular step, (ii) processor utilization associated with the particular step, or (iii) a time duration associated with the performance of the particular step.

16. The system of claim 14, wherein the graphical indicator is a gauge that visually represents the performance metric on a labelled scale, wherein the labelled scale includes zones that categorize efficacy of the performance of the particular step.

17. A computer-implemented method comprising:
generating and providing, for display on a graphical user interface (GUI), (i) a menu of at least some graphical icons of a library of graphical icons, and (ii) a graph of instances of graphical icons associated with steps of a discovery pattern, with connectors indicating directional connections between pairs of the steps, wherein persistent storage contains the library of graphical icons and a representation of the discovery pattern, wherein the steps are also respectively associated with identifiers and program logic executable to perform operations of the discovery pattern, wherein the steps include an initial step at which the discovery pattern begins, and one or more final steps at which the discovery pattern ends;
receiving an indication that an additional graphical icon from the library has been connected to a target graphical icon of the graph by an additional connector, wherein the additional graphical icon has an additional identifier and additional program logic;
in response to receiving the indication, updating the representation of the discovery pattern to include an additional step and an additional directional connection between the additional step and a target step represented by the target graphical icon, wherein the additional step is associated with the additional graphical icon, the additional identifier, and the additional program logic; and
storing, in the persistent storage, the representation of the discovery pattern as updated.

18. The computer-implemented method of claim 17, wherein the computer-implemented method further comprises:
receiving an further indication that a further graphical icon in the graph has been moved from a first position to a second position and one or more connectors involving the further graphical icon have been updated, wherein the further graphical icon is associated with a particular step of the steps;
in response to receiving the further indication, updating the representation of the discovery pattern to include the particular step ordered in the steps in accordance with the one or more connectors as updated; and
storing, in the persistent storage, the representation of the discovery pattern as updated.

19. The computer-implemented method of claim 17, wherein the computer-implemented method further comprises:
performing the discovery pattern on one or more computing devices of a target network, wherein performing the discovery pattern comprises: (i) traversing the steps in an ordering defined by the directional connections between the pairs of the steps, and (ii) for each step visited during the traversing, executing the associated program logic.

20. An article of manufacture including a non-transitory computer-readable medium, having stored thereon program instructions that, upon execution by a computing device, cause the computing device to perform operations comprising:
generating and providing, for display on a graphical user interface (GUI), (i) a menu of at least some graphical icons of a library of graphical icons, and (ii) a graph of instances of graphical icons associated with steps of a discovery pattern, with connectors indicating directional connections between pairs of the steps, wherein persistent storage contains the library of graphical icons and a representation of the discovery pattern, wherein the steps are also respectively associated with identifiers and program logic executable to perform operations of the discovery pattern, wherein the steps include an initial step at which the discovery pattern begins, and one or more final steps at which the discovery pattern ends;
receiving an indication that an additional graphical icon from the library has been connected to a target graphical icon of the graph by an additional connector, wherein the additional graphical icon has an additional identifier and additional program logic;
in response to receiving the indication, updating the representation of the discovery pattern to include an additional step and an additional directional connection between the additional step and a target step represented by the target graphical icon, wherein the additional step is associated with the additional graphical icon, the additional identifier, and the additional program logic; and
storing, in the persistent storage, the representation of the discovery pattern as updated.
